(19) United States
(12) Patent Application Publication
(10) Pub. No.: US 2015/0310761 A1
(43) Pub. Date: Oct. 29, 2015

(54) TEACHING AND PSYCHO-EDUCATIONAL METHOD AND ELEMENT: FUTTDAM

(71) Applicant: Miguel Angel SOLARI NOBLE, Montevideo (UY)

(72) Inventor: Miguel Angel SOLARI NOBLE, Montevideo (UY)

(21) Appl. No.: 14/697,126

(22) Filed: Apr. 27, 2015

(30) Foreign Application Priority Data
Apr. 28, 2014 (UY) 35.546

(51) Int. Cl. G09B 19/00

(52) U.S. Cl. CPC G09B 19/00

(57) ABSTRACT

FUTTDAM is a psycho-educational learning method that includes elements suitable for its application, generally consisting of a board and tiles, comprising exercises of increasing complexity, and that, under a ludic appearance, develops—intrinsically or in a combined way—aspects of logical, strategic and tactical thinking, specific to various team and sport activities (football, handball, basketball, hockey, and others). It also contains an element of chance and uncertainty, applicable to both normal, disabled and with special educational needs individuals, thus facilitating social integration and employment.

### DEFINITION AND STATE OF THE ART

FUTTDAM is a set of learning activities of increasing complexity under a ludic appearance, which intrinsically develops strategic and tactical aspects specific to various team sports such as football, handball, basketball, hockey, and others. It also works as a method of learning and exercise.

Several aspects of many exercises contribute to the cognitive process. Therefore, many of these exercises are presented under the form of “games” in order to be more appealing to learners, especially children and adolescents —who usually learn to live and thrive by representing reality in a symbolic way through playing. There are few cases in which the “game” is presented as a specific factor in order to help learners overcome common deficiencies, including disabilities.

The goal of our invention is to fill a perceived need for a flexible and varied teaching tool of multiple purposes and increasing difficulty levels, resulting from our extensive teaching experience with children, both normal and with developmental disabilities. Said invention is aimed at developing a teaching tool which, despite our thorough research, we have found no previous record of.

The particular forms that our invention takes includes mixing several games or sports, such as but not restricted to, checkers game and football, along with an element of games of chance which provides uncertainty to the strategy employed, and demands an adaptation to an unpredictable—or uncertain—situation. The levels of difficulty vary upon cognitive ability, age and/or developmental disability of the learner. Note that in combining checkers games with football, board game elements (two-dimensional) merge with field spots elements (three-dimensional), to which a chance factor (uncertainty), and increasing complexity rules are added.

The advantages of our invention are apparent: no computer, video games, or Internet connection needed, just one or more playmates. Another important advantage: one does not play against a machine, and therefore it encourages the development of many aspects of team play, social integration and verbal communication. Additionally, it is important to highlight the infinitely lower cost, easy accessibility by almost everyone (even when lacking electricity at home or school), and the avoidance of the alienation and isolation resulting from the eternal game against a machine. Our invention does not intend to contribute to forming gamblers, but to foster social interaction and human development.

Applying all kinds of keywords and IPC classification we found some inventions, although not specifically educational, that could resemble only some remote aspects of our invention, and only separately, not within the combination we use.

In addition, the goals we seek have migrated almost entirely to video games or online. Example include: www.brainist.com, http://www.mindgames.com/brain-games.php; http://www.brainmetrix.com/, especialmente http://www.brainmetrix.com/brain-fitness/y http://www.brainmetrix.com/cognitive-training/. Another notorious game offered at Amazon.com is “The Hunger Games”, where among to and 6 participants are allowed.

The inventions or teaching methods mentioned above cover some of our goals, but are devoid of others. Additionally, they do not use our combination of cognitive elements.

The patents or applications found are many, and their list is attached (partially). Since it would be senseless to make a comparison with each and every one of them, only the most relevant will be mentioned:

GB2180765—this patent is almost like chess but with the important modification that its pieces, due to its particular forms, indicate the different directions in which each can move through the board. There is no chance element, and it is above all—except for shape of pieces—similar to chess. The same is included for its directional indication factor.

WO2013/177343—this game is also a variant of chess. It is for four players with 18 pieces each, and the board is divided into “paths” and in external and internal zones. We included it mainly by the division of the board in different areas.

CN201150786—this application refers to a combination of chess, football and chance, which is furnished by two dice: a directional and a distance one. Its “pitch” or board is in 7×11, not being checkerboard shaped (black and white, but rather “Chinese Checkers”), and not having levels or any other educational function than that of popularizing football and its rules in China. It is the only application that combines field sports with board games and a chance factor, and therefore we refer to it as the closest prior art.

### BACKGROUND OF THE INVENTION

By 2010, the Occupational Therapy Chair of the School of Medicine of the Eastern Republic of Uruguay, included our rehabilitation and cognitive rehabilitation methodology in computerised environments (RRCEI—2001), within the set of techniques taught. Given our work in this educational environment, we set out to develop a system of ludic nature that followed the principles consistent with the aforementioned computing tasks in order to broaden the scope of educational psychology techniques and approaches available.

The following can be drawn from the RRCEI
Adequate stimulation of brain functions increases the IQ of a significant percentage of children under treatment, when it is expected to remain unchanged throughout life,
This can be repeated and systematized at a larger scale,
It promotes learning of topics which many children with mental disability (or other deficiencies), could not have understood under other forms of nowadays special education of standard practice.
The impact on children's living standard and autonomy will be favoured, leading to more active and independent social roles in the future.

### FUTTDAM and Computerized Cognitive Re-Education

Based on past experience, re-education work carried out in recent years, the unchanged population of our educational centre, we included FUTTDAM to the recreational ludic table game activities at our disposal. After thorough experiments, results have been observed, adjustments made, and a place and value of stimulant of cognitive and intellectual competencies was attributed to FUTTDAM within the wealth of resources we regularly use for our educational purposes.

Like in the RRCEI method, here, we also worked with a progression that establishes rules and levels of complexity (5 stages), which highlights the performance and/or developments of students.

Adaptations for FUTTDAM (Experimental Method and Development) FUTTDAM's progression, which led us to initially focus on the Masters level, was incorporated to the methodology of the referenced work, as an alternative in order to perform rotation activities, enrichment, or workstations.

While a child or two used a computer with educational software, other, rested the brain areas stressed by re-educational work (reading, calculus, problem solving situations, etc.) and exercised through a ludic activity, “playing”, either checkers, or ludo, etc.

Once our first prototype was developed, the children who had a good performance in the aforementioned games were asked to play FUTTDAM with proven assessments of cognitive and intellectual nature. We observed there was a direct correlation between those who were skilled and unskilled in the previously studied games.

### Common Characteristics Between Players:

Achievement or failure profiles are repeated
Increasing levels of difficulty demanded more concentration and mental stress of the child
The stress was not harmful whenever of recreational nature
it proved to be as challenging and complex as other ludic activities (more than most of them)
It was motivating, entertaining, and easy to relate to pragmatic aspects of reality
Only those children who were more skilled and mature showed the best and most successful tactical and strategic approaches.
Some less skilled children were able to win because of the chance factor.
The game favoured cooperation and leadership among children
Children were bored or overly accustomed to traditional games.
Those games employed for recreational purposes do not directly contribute to educational, teaching and learning processes that promote the maturation and psychosocial development of the learner.

### Ages

Given the age spectra, the invention can also complement the training of adults. FUTTDAM Jr. Pro Jr. is designed for children of approximately between 6 and 10 years of age; Master Pro Jr, between 11 and 15 years of age; Master, Master Pro and Master Libero over 15 years). The mentioned ages are more related to the performance than to an age group, and therefore there are people with a certain chronological age who will be able to play at levels of less or greater difficulty than their age group.

### Remarks in Cognitive and Intellectual Aspects

We ensured that when playing FUTTDAM, children and adolescents used skills and competencies such as:

| | |
|---|---|
| Visual perceptual | Mnemonic |
| Observational | Inferential |
| Attentional | Logical |
| Socializing | Globalizing |
| Intuitive | Structuring |
| Analytical | Organizational |
| Synthetic | Associative |
| Affective | Empathy |
| Ethical | Value |

Similarly, we observed by direct participation in football training categories (age groups from 6-16 years), that the group of children-adolescents we study and the group who plays and learn in sport teams within the field of our competence, bear common characteristics. In fact, there is often a permeability in the context of shared education (school or basic education, and secondary formal education, baccalaureates), with and without Learning Difficulties and Special Educational Needs for football, but not vice versa in equal measure.

This has been recognized by the state of our country, declaring the Educational and Pedagogical Element and Method FUTTDAM of “Ministerial Interest”, through the Ministry of Tourism and Sports of the Eastern Republic of Uruguay, National Sports Division, 0938/14, Jul. 3, 2014.

### SUMMARY OF THE INVENTION

Our conclusions were that the aforementioned statement, in conjunction with the methodology followed and exposed in the previous pages, with proper caution, allow to infer possible applications and have prospects of success, with a high probability that FUTTDAM, with its 5 Phases progression, may result a significant contribution to cognitive and intellectual stimulation, both for the tested population (in our Specialized Educational Centre), and those with whom we had direct relation in the field of team sports, especially football, and by extension, those under Regular Education.

### DETAILED DESCRIPTION OF THE INVENTION

What does it consist of

Its platform

Evolutionary complexity

Strategy, Tactics and Intuition

Uncertainty Principle

### Strategy and Tactics Evolution of Team Sports

FUTTDAM is a set of learning activities of increasing complexity, which intrinsically develops strategic and tactical aspects specific to various team sports such as football, handball, basketball, hockey, and others; of social and group activities, and it also works as a learning and training method.

Its professional and technical use attains through its progression a pedagogical, psychomotor, and teaching value when working with it as a methodology and not just as a ludic and recreational platform.

It is set on a physical platform, “board”, designed in 5 phases of increasing complexity. The same relates to models in which the working surface changes —checkerboards—pieces, and game rules.

Inherent strategic, tactical and Intuitive aspects of several sports, merge together on an physical recreation, on a checkerboard—in terms of surface rows and columns—designed to work as a “field”.

It also allows deliberate uncertainty through the use of a die, timing if desired, and the participation of more than two people simultaneously.

### Synthesis:

Basis of its conception

Initial applications

Functionality

This educational and psychomotor method of ludic nature is conceived as a/n:

1. A technical, professional, educational and psychomotor tool.

2. Methodological resource and/or teaching procedure and exercise for regular, specialized, physical and psychomotor education

3. Cognitive training, tactical, analytic, projective, and structuring exercise.

4. Interactive activity that reinforces social interaction

5. Means of recreation, entertainment, or game (specific recreational function).

### As an Educational Psychology Resource, FUTTDAM:

Promotes abstract thinking of “team” and “field” situations.
Promotes mental representations of sport situations.
Recreates problematic situations of everyday life with a wide array of possible decisions.
Stimulates the higher brain functions, and works with basic learning devices, players and trainers regularly use
Enhances understanding of the link established and limits set, as these are favoured when incorporating and linking the individual to regulated situations with low sequential phases (e.g., a change in the value of the pieces, use/disuse of certain rules, the idea of area, ludic reflection over the link created, etc.)
Stimulates cognitive plasticity, unlike to the routine and inflexibility set by games of linear nature.
Since uncertainty is a recurrent factor (like in daily life), it does not lead to failures caused by age, cognitive, or experiential differences between participants. In this sense, the most novice, younger or with less potential individual, can successfully reach the end (the individual's failure is not strictly related to their capacity).
It involves exercising inventiveness and imagination, both because it is a “new game”, and it also incorporates new rules, which should result in glial specific and significant increases, in accordance with the effort and working system employed.
Has variable rhythms and intensities of intellectual work. The same vary in accordance with the level, increasingly intensifying (it quickly increases its choices and opportunities). It has a plateau phase that can be repeated (with difficulty, pace, complexity of steady decisions), and it can end with high working intensity, or a few moves (comments to date).

### FUTTDAM as a Psychomotor Resource

Progression takes part in the proper development of the spatial organization; in this sense, the ability to guide and direct the movements within the space is essential for survival and proper human development.

FUTTDAM strengthens patience —impulse self control—when waiting for turns, it encourages children to make decisions calmly since proper planning, foresight and use of strategies and tactics are required. This could also help children understand that thinking of a course of action to take and making the right decisions lead to better results.

It is a method-game that can be used in a psychomotor room, while it is possible to take the game from its board to the wide space of the room, i.e. play the game dynamically by using pieces of cardboard, ninepins, balls, among other materials, and play the tactical moves with motor skills involving the whole body, through general dynamic coordination. This aspect allows socializing, communicating, interacting, assuming different roles and moving from accompaniment and agreement to effective leadership.

### It Follows the Maturation Pathway of the Child-Teenager.

Throughout school, group, and secondary education (secondary cycles), specific maturational skills are brought about, and the same correlate with the difficulty levels or stages of FUTTDAM. This allows adapting the stimulus work to the grade level of the student, and puts forward an improvement through its method practice.

### Research: FUTTDAM′ Potential

Our assessments position FUTTDAM in its most complex levels (Master, Pro and Libero), in an intermediate range between Checkers for phases 1 and 2, and Chess, for phases 3 to 5 also, being closer to the latter in its possibilities and complexity. The last level, has especially a wide range of combinatory actions, and therefore adult thinking is involved throughout the proposal.

FUTTDAM, is a progression with characteristics of the world of Sports Sciences, Psychology and Educational Psychology, as its scope is relatively wide and probabilistic, without detriment to the logical sequences involved in its moves, tactics and strategies.

Therefore, its approach can be classified within the studies of “not accurate” Sciences and result beneficial, promising and interesting to further research and longitudinal studies.

### Synthesis:

Talent for sports

Capacity development

Invisible Training

a. We note that a talent for sports could arise in an intellectual and cognitive way, for it skills and tactical and strategic capabilities (although not reflected in a field). FUTTDAM, has affinity with team/field sports, employing a wide range of situations common to them. Talent and inclination to sports, can be also discovered with activities like these. In fact, maturational differences between members of a team can lead to a poor physical performance, whilst the training of their mental skills can be put into practice.

b. There are records of remarkable cases in which people with no outstanding career in the discipline they impart or teach who have managed teams and institutions by developing their tactical and strategic thinking.

In view of the aforementioned, a talent for sports can be outlined from “outside the field”, since children can develop their thinking, human potential, and motivation abstractly, through a way which is similar to the principles, tactics and strategies of a sport.

A father/or teammate playing with a child on a rainy day, or a Sports Teacher/trainer instructing and motivating the child, constitute a valuable contribution in the area of “Invisible training”, especially from mutual entertainment and relationships.

As a cognitive training: According to our observations, this game-method reinforces psycho-motor performance of training and sports more from the psychological point of view than a motor one.

The use of rules, colors, different areas and reading levels, promote a multivariable thinking. Operating with such a wide range of options, not only of “logical choice nature” but also of human predictability, since the opponent's moves can be intuited, perhaps anticipated, promotes a different dimension of the bonds and human knowledge among individuals, friends, family, etc.

Lateral thinking is manifested when the player is propelled out of the “logical” and customary way used in checkerboard games, through two levels of uncertainty: what the player does, what we think we could do. We change the random password, De Bono (1967), for the number of a die, then the generated possibilities are examined, and moves hypotheses are made. These are initially in accordance with what the player believes, not how the opponent will react (which is what will actually happen), nor how chance will allow. There is usually a hypothetical position, and there is speculation on what would happen.

From the aforementioned, we could deduce that making a critical strategy may be a skill required to conquer, which is highly beneficial in working and social environments.

The observed situations demand, analysing, synthesicing, projecting, deducting, anticipating, speculating, imagining variants and having self confidence instead of desire for success.

It makes us deal with the Stroop effect in a reduced manner, since it works with visuospatial discrimination, attention, change in meaning of the binomial figure-ground, and mental fatigue; and promotes concentration, sensory, perceptive and attention-focused discrimination.

It projects onto the board size the difficulty of moving the mental representation to the wide space of the field in general, and of isolating in a successful way areas which are similar to reduced spaces.

It may be useful training when it rains and there's nowhere to practice (training) instead of just not practicing and losing training experience.

Those who regularly play football or team sports usually prove a better performance than those who do not (there is a link—association), both for regular education population as SEN (special education needs).

Phases 4 and 5 correlate better with those who opt for vocational-technical education, reaching an adult maturation level. Our the special interest in the training of those who usually only adjust to the other stages: with practice and teaching, they will be able to develop their potential, as well as improve their social and working skills.

As a Didactic Game: It related to, and to some extent heir of Uruguayan traditional games such as “Tabs”, marbles, football, and hopscotch, which by their general principles, we believe, would be related to the functional structure of FUTTDAM.

It has a certain kinship with other aspects of useful and widespread games, such as the Checkers and Chess.

Given its increasing difficulty (Levels: Junior, Master and Master Pro), it allows different age groups, and/or performance levels. The forementioned allows the organization of tournaments perlevels, which go along with the development of the participants.

The number of possible moves and difficulty grade in Master's version is significantly higher than traditional “Checkers”, and less than the highest levels of Chess.

Functionally, it incorporates to the checkerboard the complexity of various activities, which acts as ergonomic bridge, mediator or intermediary between various recreational proposals; thus filling a gap in this field, which hindered the access from certain performance modalities to more complex ones: it stands for accessibility.

In its five levels, it has 70 variations of rules comparing with checkers.

It exposes participants to fairly open and nonlinear situations, where intuition and knowing the opponent are advantages.

It promotes speculation through the zonal conquest, and basic defensive strength (necessary and convenient when employing a die) without mechanical linearity, but rather strategic and related to opportunities.

It is suitable for intergenerational interaction and cooperation. It allows parents to take part of the activity (sometimes inconveniently channeled through field activities). Elders can obtain psychogeriatric benefits through practice and neural-cognitive stimulation, which represents a contribution to preventive health of neurodegenerative normal damage.

Of easy accessibility, users benefit from the phases of variable complexity in which their potential and initial basic knowledge can be fit, instead of offering from the beginning of each proposal a cumulus of complexity that covers all possibilities during the game.

Chance and uncertainty intervention (regulated and controlled) can level the intellectual, maturational and experiential forces; sometimes the winner will not be the “more capable” but the one who conquests (typical of football/soccer).

The intervention of a movement similar to football's short and long passes is gradual at first, and then more circumstantial. It encourages the player to think of midrange “definitions”, which often lacks in training games. It encourages the taking of decisions and responsibilities.

It exposes the players to fairly open and nonlinear situations, where intuition and knowing the opponent advantages.

It promotes speculation through the zonal conquest, and basic defensive strength (necessary and convenient when employing a die) without mechanical linearity, but rather strategic and related to opportunities.

Chance and uncertainty intervention (regulated and controlled) can level the intellectual, maturational and experiential forces; sometimes the winner will not be the “more capable” but the one who conquests (typical of football/soccer).

Example of Gaming Board and Chance Element (none is exclusive). Master, Master Pro and Master Pro Libero are provided in Figures.

### BRIEF DESCRIPTION OF THE FIGURES

FIG. 1 shows an Example of rules FUTTDAM (from a ludic perspective).

FIGS. 2A and 2B show an Example of moves on surface (checkerboard).

FIG. 3 shows an Example of the different decisions a player can make.

FIGS. 4A and 4B show non-restricting examples of work surfaces designs (boards), versions Master, Master Pro and Master Libero.

FIGS. 5A and 5B show current management system of the methodology according to the invention.

FIG. 6 shows indications for operating with several rounds according to the invention.

FIGS. 7A, 7B and 7C show PERT and Basic Work Guide according to the invention.

FIG. 8 shows FUTTDAM's phases, User Chronological Age and Most Relevant Observed Principles according to the invention.

FIG. 9 shows a FUTTDAM JUNIOR board.

FIGS. 10A and 10B show tables useful for mathematical exercises.

FIGS. 11A and 11B show non-restrictive example of board for Junior and Junior Pro versions.

FIGS. 12A, 12B and 12C show examples of a game akin to team sports according to the invention.

### DETAILED DESCRIPTION OF THE FIGURES

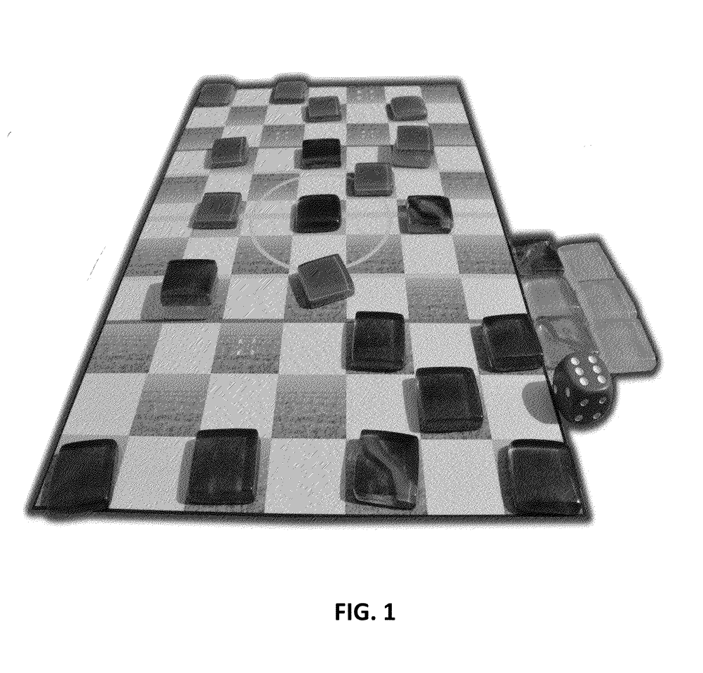

In FIG. 1, an Example of rules FUTTDAM (from a ludic perspective) is provided.

### Kickoff

It starts whoever got higher points, or until play off

### Zones

Marked by magenta and yellow lines
In Junior Own Zone (OZ), from 1st to 4th row
Junior Pro incorporates a Midfielder, which moves in X to
Middle Zone
Master Defensive Zone (up Yellow Line)
M. Pro Defensive Zone (up Magenta Line)
M. Libero Defensive Zone (up Magenta Line)

### Goalkeeper (Leader Defenders)

In Junior Move in X to yellow line (row 4 inclusive)
J. Pro Move in X to yellow line (row 4 inclusive)
Master Moves in X to row 4 inclusive inDefensive Zone (yellow line).
M. Pro Moves in X to row 4 inclusive inDefensive Zone (yellow line).
Libero M. Moves in X to row 4 inclusive inDefensive Zone (yellow line).

### Midfielders (Multifunction Offenders-Defenders)

Junior Pro Moves in X to opponent's Defensive Zone (yellow line, row 7)
Master N/A
M. Pro Moves in X to opponent's Defensive Zone (Magenta line, row 9)
M Libero Moves in X to opponent's Defensive Zone (Magenta line, row 9)

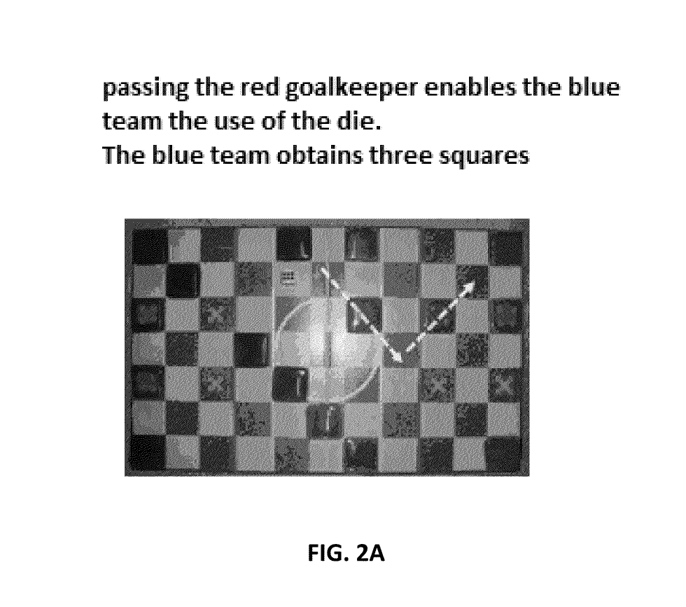

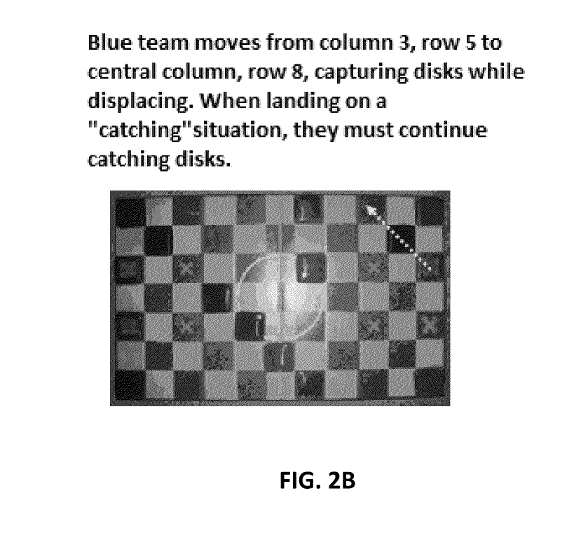

In FIGS. 2A and 2B, an Example of moves on surface (checkerboard) are provided. More particularly, in FIG. 2A passing the red goal keeper enables the blue team the use of the die. The blue team obtains three squares. In FIG. 2B, blue team moves from column 3, row 5 to central column, row 8, capturing disks while displacing. When landing on a “catching” situation, they must continue catching disks.

### Die (Vehicle of the Uncertainty Principle)

Can be used when:

Central and an adjacent squares are occupied (Central Zone)

The opponent passed a player from his Finish Line

There is a player Rival in a Defensive Zone of 3 rows, or two players 4 rows in the defensive zone of the opponent.

Die can be refused, except when the player is note allowed to move

### Multiple Displacements

### Can be Made Through:

Multiple catching (multiplayer), following the rules of the Ckeckers games

Movements of several squares with a wild card

For movements made by a die. These can pass over two tiles, own or from the rival.

Differences with Checkers Game

The stipulated Golden Rules are a way to see how it differs from another game. Likewise, we outline:

The visual-perceptive design of FUTTDAM, does not constitute something neutral or generic such as in Checkers.

Having equal number of gaming tables, higher difficulty is apparent in FUTTDAM.

The latter is a progression whilst Checkers is not.

The language used in FUTTDAM, allows players to become acquainted with team sports, and, indirectly, stimulates social interaction. Timing and pace is of higher intensity and more lengthy in FUTTDAM. Fotkers offers different alternatives or a wide range of decisions, non-linear for most moves.

Although it was originally designed in 2013 as psycho educational method consisting of a simplified representation of pitch situations (soccer), both for formative ages and adults (6 years onwards), it is does not constitute a method to exemplify a real soccer game, nor lay the foundations for planning tactical aspects of a specific encounter.

It is just a teaching method, different from football-soccer, basketball, hockey and handball, although it has similar tactical and abstract situations, which will be extremely useful in the workplace in general and the use of Cognitive and psychomotor functions such as:

| | |
|---|---|
| Visual perceptual | Mnemonic |
| Observational | Inferential |
| Attentional | Logical |
| Socializing | Globalizing |
| Intuitive | Structuring |
| Analytical | Organizational |
| Synthetic | Associative |
| Affective | Empathy |
| Ethical | Value |

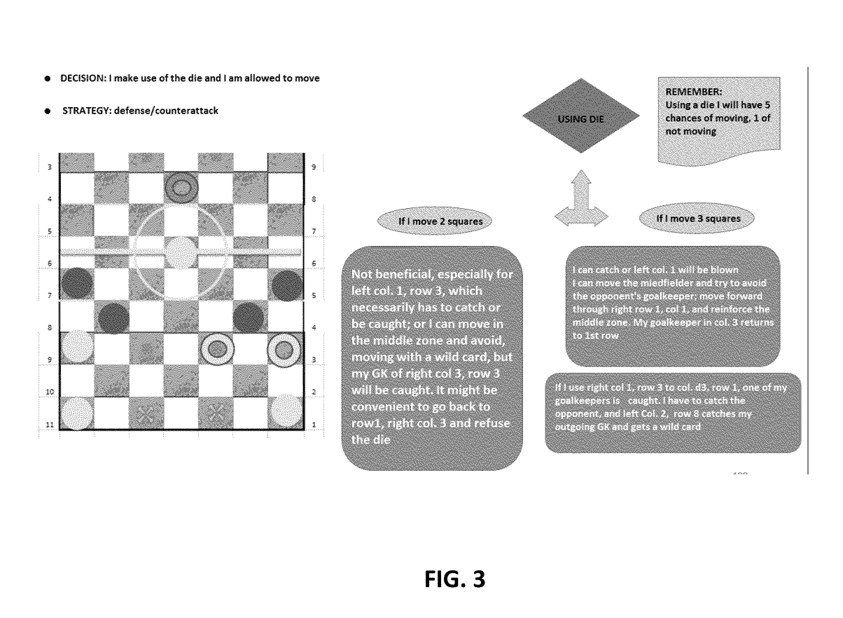

In FIG. 3, there is provided an Example of the different decisions a player can make.

In the field of Special Education (for which the invention was originally designed) it is a useful and versatile ludic tool (see ICD 10) which applies to several Psychological and Psycho Educational profiles.

Additionally, the fact that it is divided in different difficulty levels provides accessibility to people of different ages and backgrounds, so it is not a restrictive game in itself.

Some Disorders that May Benefit from FUTTDAM.

Our research shows that potential difficulties and benefits obtained when playing will depend on the type of person the players are, their skills and knowledge system:
Specific disorders of speech and language; articulation of speech; expressive language; receptive language (in cases of sensory disorders)
Dysphasia
Mild mental retardation and/or low IQ
disorders specific to the development of academic skills
specific reading disorder (eg. Dyslexia)
Specific disorders of arithmetic skills (dyscalculia)
mixed disorders of scholastic skills
Attention deficit/Hyperactivity Disorder (ADHD)
specific emotional disorders in early childhood
Social anxiety disorder in childhood
Other disorders of development scholastic skills

We noted that the permeability towards soccer in the context of regular education (school and secondary education), with and without LD and SEN, can be partly reversed, thus enabling youngsters who abandoned their studies develop their potential, and resume training activities in several business areas.

Our conclusions were that the aforementioned statement, in conjunction with the methodology followed and exposed in the previous pages, with proper caution, allow to infer possible applications and have prospects of success, with a high probability that FUTTDAM, with its 5 Phases progression, may result a significant contribution to cognitive and intellectual stimulation, both for the tested population, and those with whom we had direct relation in the field of team sports, especially football, and by extension, those under Regular Education.

General stimulation of cognitive and intellectual skills a player requires to play FUTTDAM allows to have different scenarios in which a pycho educational progression in sought, consisting essentially of:

### Set of Rules:

### Board Design

Total number of pieces per player (8, 11)

Variants of pieces per level (V and X, 2X and 4X, and Wildcard)

Zones of displacement

Relative function of parts (defence/attack/conversion)

Changes in the value of pieces (zonal/promotions)

The introduction of chance factor-uncertainty

Increase in options

Binomial uncertainty-structure

Mental effort required

Timing, etc.

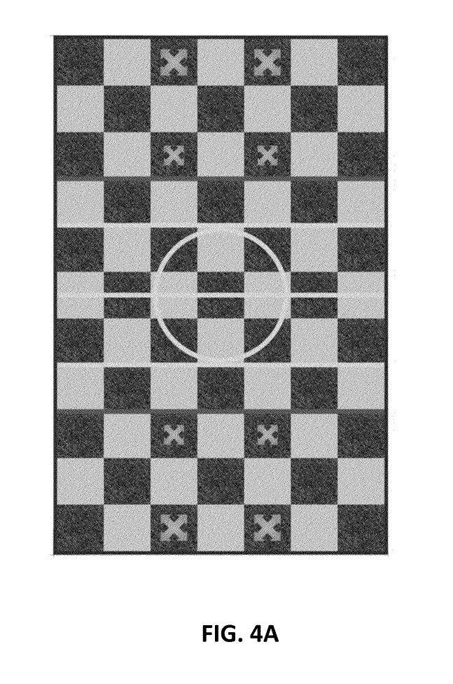

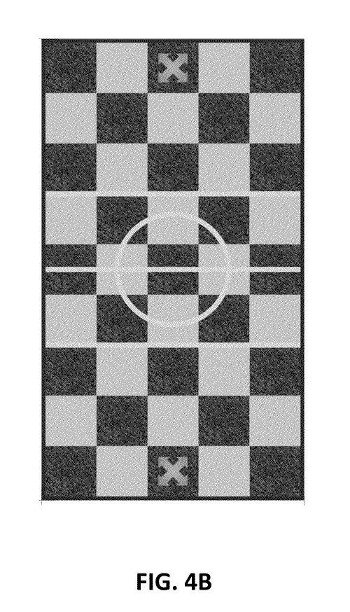

In FIGS. 4A and 4B, non-restricting examples of work surfaces designs (boards), versions Master, Master Pro and Master Libero are provided. FIG. 4A is Master, Pro Libero, and FIG. 4B is Junior and J. Pro.

Pyschoeducational Progression:

From our experience, we believe useful—although not essential, having as an antecedent for the progression (for performances in Master) previous knowledge in Checkers game (Suggested as a zero stage). Likewise, learning Master before Pro and Libero versions.

Likewise, SEN children who did not learn or forgot Chess, do play in Masters, although lacking some oversights, and showing weaknesses in implementing and maintaining rules. We noted that they perform better in Checkers, but at the same time, they are more experienced.

We infer that the degree of difficulty of the Master, is intermediate between Checkers and Chess.

How Long does FUTTDAM Last as a Working Tool?

In the beginning it lasts years, depending on how players progress in learning, skills development, hours of play (annual, monthly, etc.), and other variables. The cognitive-behavioural reinforcement exercise can lead them to follow the progression, when having stopped practicing for a long time. This favours the intellectual re-stimulation, and acts as preventive activity of mental deterioration, leisure, inaction, lack of exercise and similar factors.

Although this is a commercial aspect, reference to it is made so that the examiner can appreciate the width of applications of the invention, its flexibility and the wide scope of the population to which it may be helpful. Both versions will be sold separately, as are aimed at different users, including institutions.

1. Those for leisure, domestic use, which may be purchased at any store. It includes instructions, examples, and a brief presentation.

2. Also, we will have another parallel edition, Pioneer Professional, aimed at those who work with tools and related methodologies: Sport Technician, Sports Psychologists, Educational Psychologists, etc.

The latter will include a CD with technical data, our complete presentation in Power Point, and related data useful for the dissemination and implementation of the method as a whole.

### Educational and Methodological Principles

In the field of sports, for the training of sports of physical nature (not always psychological or psycho-pedagogically oriented), we apply principles known to Sports Technicians and Physical Education specialists.

Of these principles, some have been employed in order to base an initial Work Method and strengthen the link between physical and psychological work.

Why is this possible?, because, for those who conceive the neuropsychological aspect as a material reality, mainly of extensive and intrinsic body reach (covering the whole spectrum where an axon, a neuron, a neurotransmitter acting, or the effects of CNS glandular secretions reaching every inch of our body), will note that the so-called “brain” (reductive and misleading expression of the Neurological system), is also an organ, and therefore has qualities similar to others, sharing in its functionality, and reciprocal interaction aspects that can be worked on in a relatively similar way, if we conceive it as something forming an inextricable part of a whole. Obviously, the part should not be mistaken as the whole.

### Basic Cognitive Aspects

A) how do we Know that FUTTDAM Stimulates Our Brain?

Because normally, any activity of daily life (except for exceptional situations), cause neurological stimuli, conscious or not, awake or asleep, and this is the practice in FUTTDAM. It is also an activity with such potential. It has been tested with the students of our Educational Centre who show mental fatigue, concentration, effort, request for training, etc.

B) How do we Know it Acts on the Intellect?

For said rational, intuitive and complex human cognitive power, must be employed during a game, and it is necessary for the development of any similar procedure, otherwise, the activity does not develop following the basic rules.

Also, because previous studies (including imaging and PET) showed brain activation in areas of intellectual skills competence while performing similar games of lesser and greater complexity than FUTTDAM.

Some Strategic Aspects:

During the progression, strategic changes are observed as players gain experience, or also, in accordance with their prior learning.

Some employ the logic of “Checkers”, especially in Junior and Master; which is reversed with learning, technical guidance, practice and error, and emulating the performance of the most skilled and experienced.

Others adapt from the start, with more plasticity to the possibilities offered by the rules, and seek, for example, to secure areas and positional domain, or wait to counteract (proposed little but defend with solidly and control their excessive impulses to action); choose to leave the side pieces stationary and capture with Goalkeepers, so they can return to a 4 row formation which becomes very difficult to be beaten.

There are those who seek to quickly reach “long shots” allowed by the die, without adequately assessing other factors (positions, groupings, blocks, free/occupied sectors, etc.), and resort to chance, the “luck” than would be a hit, although it is playing in uncertainty.

The most immature-inexperienced, tend to move forward as quickly as possible, and seek to reach a piece of large displacement—Wildcard—even sending isolated pieces against several opponents. The notion of team, group and mutual support appears along with the experience.

The less effective players lose the notion of “court-team” and grasp partial aspects of FUTTDAM, managing specific sectors and situations, more or less randomly. This is also teachable and improvable.

### C) How FUTTDAM Stimulates Our Intellect?

As much as any other similar recreational activity, from a level similar level to Checkers to a level closer to Chess, as we move forward in its 5 Phases. Evaluations by comparison, lead us to think that within the 10 levels of difficulty of Chess, FUTTDAM allows a performance close to a level 4. In other words, it can be complex for the average adult. Perceptual and mnemonic errors, reduction of plays in favour of simple movements, rash decisions, thoughtless moves, loss of savable pieces, alterations to the rules, forgetting one's turn, etc., give us an idea of effort and stimulation rate that the player has received.

Observations and Age Progression:

Based on principles such as the following, we work and propose a progression that follows the line of the 5 phases already described from a psycho educational and psychomotor viewpoint.

It is recommended to evaluate the child-teenagers with whom one is to work, and assign a place of beginning, through an inductive or introductory process that allows them understand the rules in accordance with their skills, practice, age, ability, etc.

We worked watching people who were:

Not skilled for Checkers

Skilled for Checkers, but not for Chess

Skilled and unskilled for other games (e.g. Ludo)

Skilled for Chess

Our development FUTTDAM methodologically assigned phases to these people. In testing them, looking for matches or not we found that, depending on the level of performance with other games, an individual fits more or less, better or worse in the phases of FUTTDAM.

In order to stimulate the growth, maturation and development of skills and competencies, an individual who proves unskilled with Checkers game, can start with a Junior Phase; someone who performs well in Checkers, but not in Chess, depending on his/her age, can start with Junior Pro or Masters directly.

Thus, through matching and projecting those games to our progression, we infer what level someone can have and set a work program of sequential nature.

Principle of Continuity:

Encouraging a sustainable progress, of months/years avoids pauses or prolonged periods of inactivity. If FUTTDAM is used as a tool, not a play or fun, it should be practiced regularly, e.g., 2 or 3 times a week (RRCEI Method—2001—The CEIS effect—2003—, and hypothesis on periodic dream Processing, MAS., 1987) to maintain a high level of performance and improvement.

Principle of Individualization:

We focus on participants, not on the results obtained primarily (useful for quantifiable assessments, comparative studies, etc.). Everyone has to get benefits of the practice, and except in the case of a championship, our activity, seeks the growth and development of the participant.

Principle of “Focus of Intervention”:

It is not difficult that technicians can be led by the game played by opponents; in their hands, FUTTDAM can be a game, in ours, it is a methodology. We must focus on the task and not expect the progression acting by itself but, dare to be indicative, promoters, advocates of experience and guides of the principles. It is also essential our playing in order to command the possibilities and difficulties presented.

Principle of Load Progression:

If we consider the “loads” as quantums of information that the players will handle (presumptive units to be established), which from this perspective opens the path of Computing to Sports Psychology, we can liken the work required to play (mental, physical, emotional, etc.), to concepts such as intensity, volume, density, and others, emphasizing the work/rest relationship, in order to avoid mental fatigue and unwanted loses

Principle of Cyclical Loads:

Fatigue and recovery processes are not linear, but of undulant matrix, such as biorhythm; the cyclical organization of the game in phases allows, within certain limits, a progressive increase in performance. In sports, it is observed that adaptations are undulant, and relate to bio and circadian rhythms.

Principle of Multilateralism of Specialization:

The younger children are let to play from time to time; if we are with athletes, the same applies. Often, tangentially, we exemplify and standardize the games with what they practice in sports. Thoughts will not be addressed directly to FUTTDAM in order not to lose adaptive richness and freshness of children own thinking. We recommend that children discover through guidance, they can think abstractly what they do in a field. In this sense, we avoid that a child in real game situation can be confused thinking beyond the game and being distracted, and also in order not to discourage those who do not have a good performance in FUTTDAM from playing field sports.

Principle of Total Quality:

We note there is a cycle or circle DEMING E. Williams (Total Quality), adapted to the best sports performance:

1) Planning

2) Action

3) Assessment

4) Correction

Variability Principle:

Changing and modifying activities and problematic situations tends to favour the performance and adaptability of the participant, and should therefore periodically intersperse higher levels of work (not too frustrating), eg., from spending a couple of weeks playing master to some casual games in Pro and Libero, or, in the case of children who work comfortably and at ease in Jr. Pro, change from time to time to Masters, and then return to the optimum level of performance proved.

Self-Understanding Principle:

Promoting reflection on why one played well, what mistakes one made, what defined the game, when one started to win, etc., help players mature, become aware and know where to focus their efforts. It gives confidence and direction.

Health Principle:

Our decisions have to maintain and strengthen the health of the participants; this is not always apparent, since participants sometimes are tired of school, going out, etc., and stressful consecutive games may stress and tire the individual as well.

Rating the workload when playing helps increase sustainable achievements.

Gradual Habit and Practice Principle:

Referred to stimulating the taste and pleasure in the activity itself without falling into gambling, as opposed to the passive contemplation offered by other purely recreational activities.

Principle of Respect of the Needs and Interests of the Athlete/Student:

There are athletes who may not be interested in practicing with FUTTDAM, which is perfectly valid; some prefer to live sports from direct and immediate intervention with other aspects, and thus get what they want. Similarly, there are children in schools that do not engage with board games, and therefore they do not take advantage of their skills.

Principle of “Men” Progress:

Our methodical and technical intervention, with or without tools and ludic methods, can contribute to human development through knowledge, in all its dimensions; it is in oneself, to find out how.

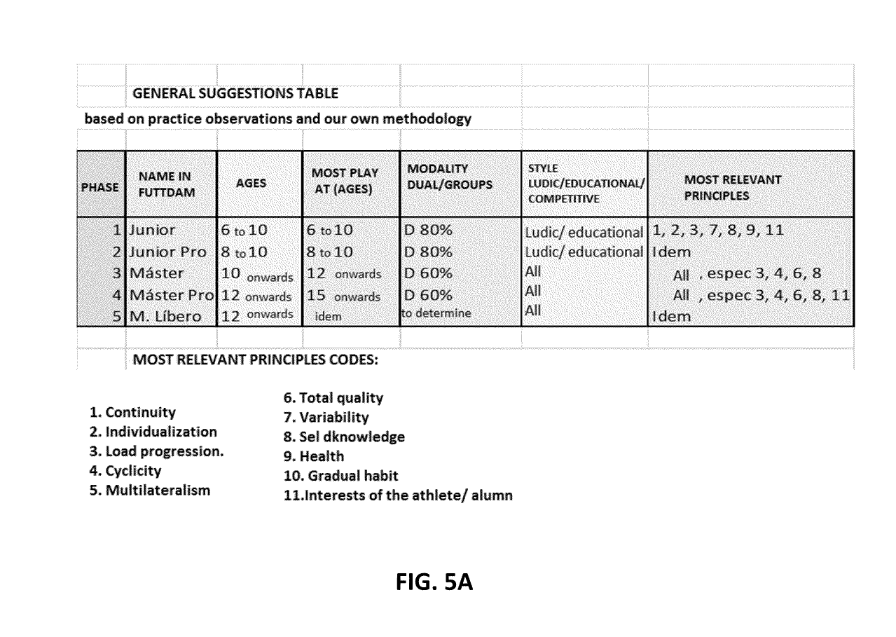

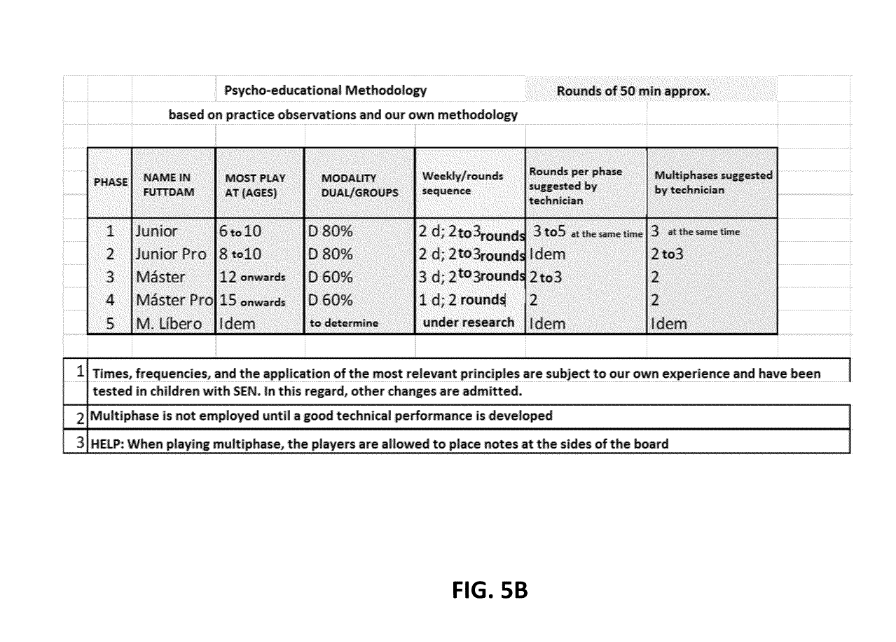

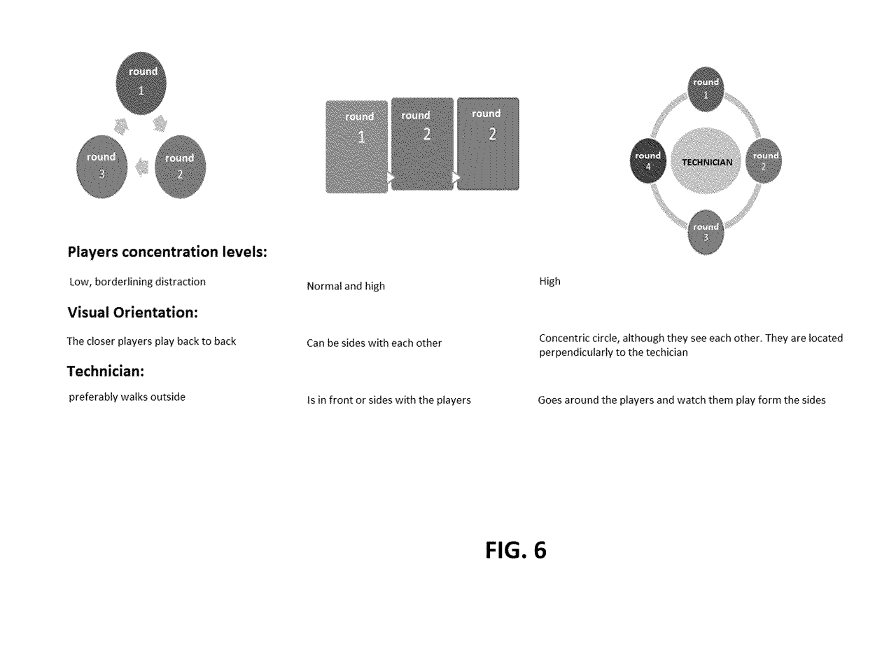

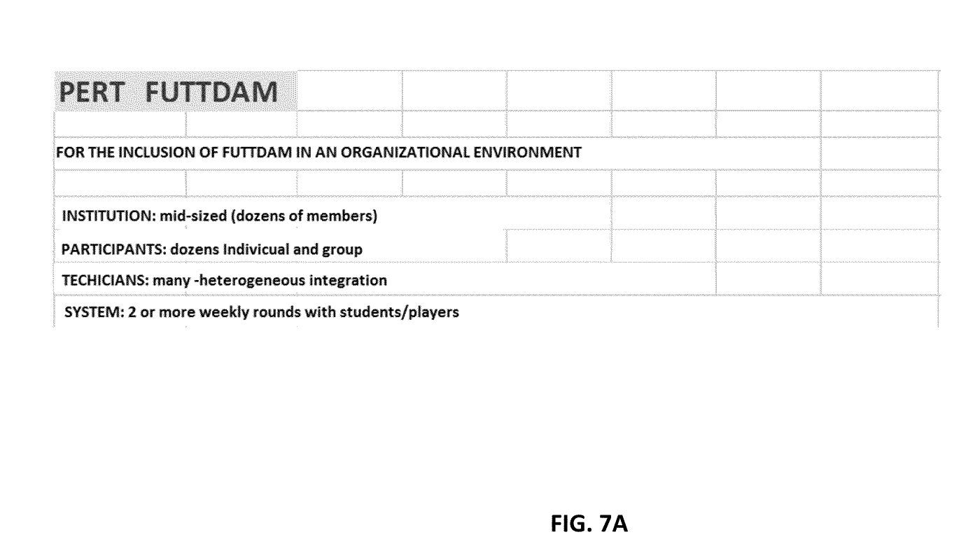

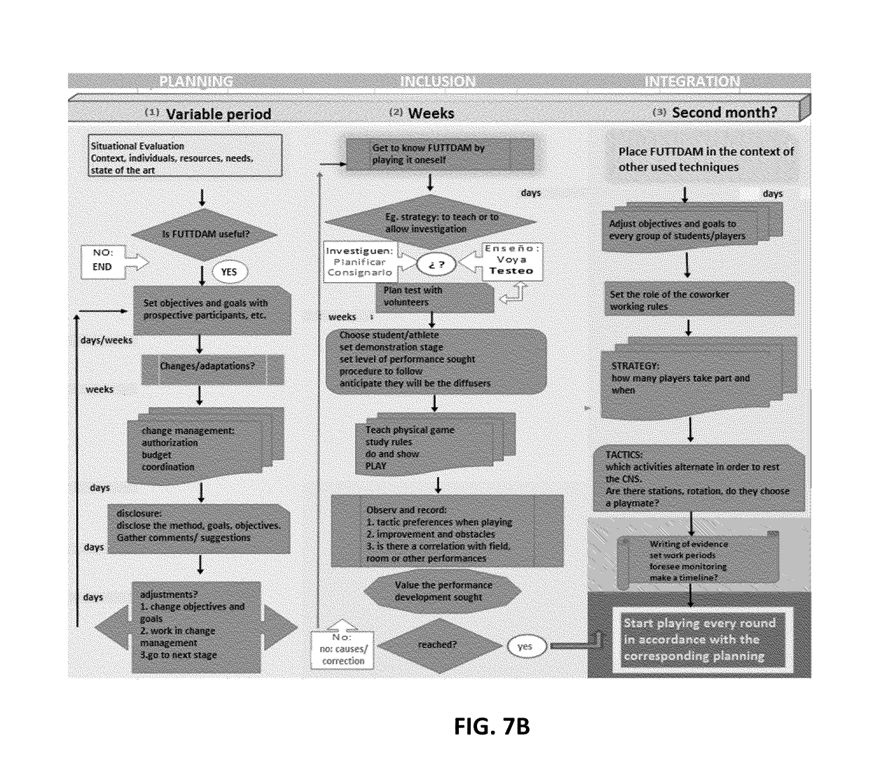

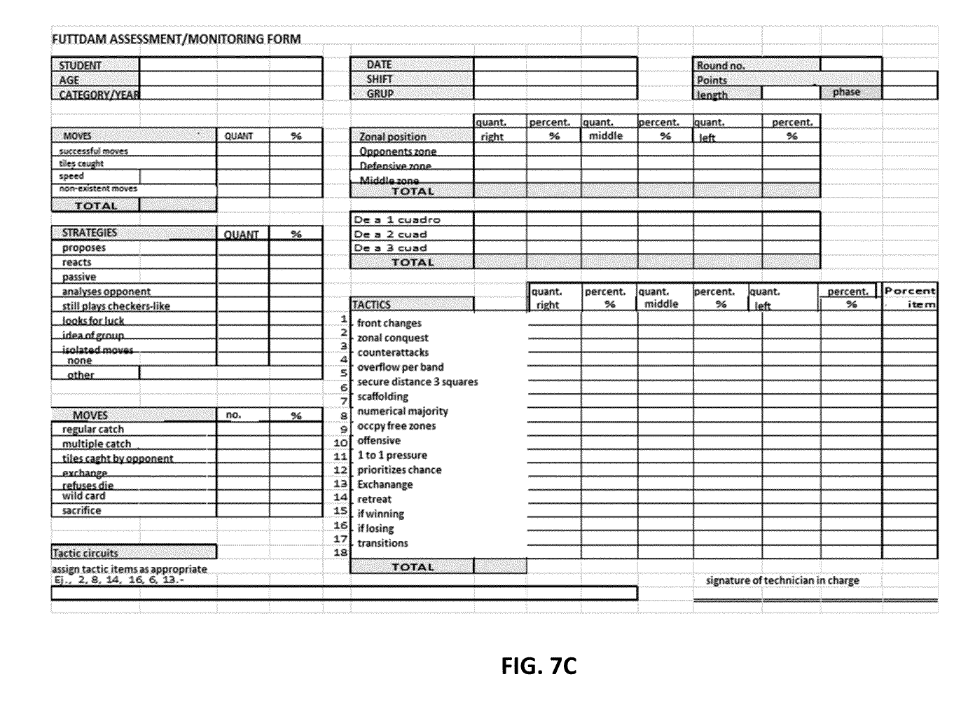

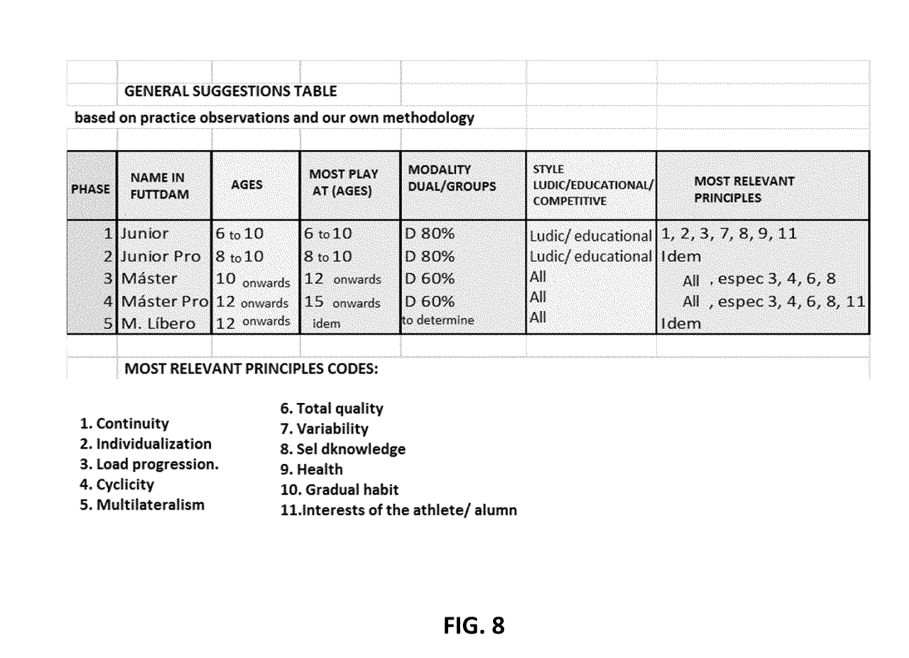

As provided in FIGS. 5A and 5B, the current management system of the methodology is based on the following macro variables:

Objectual mode or “board”

Multidisciplinary (affecting several Technicians)

Psycho educational/psycho didactic (although “Psi” is the broad field of common reference)

Participatory (requires interrelationships and some proactivity)

Customized (The method will be adjusted to the player/participant)

### Technical Language and Our Intervention

In the teaching process from the beginning of Phases, we proved useful to refer to pieces as “players or tiles” and is easily understood by all; we adjust to the users' general knowledge for their own benefit.

Regarding the plays, initially, a related terminology to other board games can be accessible to players/students, but once installed and habitual, we can move into more technical concepts, and talk about zones, walls, long passes, pressure, conquests, etc.

As experience and autonomy are acquired, the trainer can participate in less specific aspects, and can abstract and ask from a language specific to a sport the participants play, e.g., “Can a long shot destabilize the defence?” “Isn't the attack too open and in numerically inferior?”

Since FUTTDAM includes tactical modes of several sports, the language of trainer, when abstracted and oriented to a Sport, will be favoured with associations like the above, contributing to the specificity of cognitive training Player. This does not prevent us fostering thinking in a SWOT, and abstracting situations, speculating, evaluating situations in an analytical and comprehensive manner.

In the Psycho Educational classroom, references can be less specific, and also get the expected results for a work session.

Our practice and the Player/Student's abstract thinking

We include in our procedures a few observations to work with, closely related to the principles of e.g. SWOT.

What is the opponent's strategy?

Does the opponent have a strategy; what tactics are being used, what now?

What round does the opponent want to play and what do I want? Do I think in order not to risk?

Am I rushing because I'm “nervous”?

What does the opponent get with this particular move? And what if the opponent moves or I move . . . ?

What zones are now conquered, by whom, and what in dispute?

Is there free zones or vulnerable parts?

What are my strengths?

If I get long moves (2, 3 or more squares), how it affects each tile, each group, my tactic, and the zonal positioning?

What if I get with die “can't move”?

How I feel in this round?

What mistakes and scores am I making?

Is today a good day for FUTTDAM?

Our teaching tool, which employs elements of a game as an indissoluble part of the learning process, can have many rules, and indeed there are different rules for each level. There could be many others, therefore the exemplified below are just a set through which the essence and implementation of the invention can be grasped. Another user could set other rules, as there are for example many for varieties of chess, but the “hardware”, the didactic concept, and its implementation in order to improve conditions in some children and adults are the essence of our invention, which—in our humble opinion, cannot be appreciated without at least some rules that illustrate its operation and mental processes resulting from it.

Example Use of Tiles and their Meanings

### Tiles

V are movable forward to Right (R.) Or Left (L.)
V0 When displacement is zero
V1 When V moves to one square
Greater V1 When several V are moved in units
X are movable to R, L, forward and backwards
X0 When displacement is zero
X1 When X displaces one space unit or square (Right, Left, Back, Forth)
Greater X1 When X displaces several space units or squares

### Die

### Coded Values to Match the Needs:

If once thrown the results are:

1 or 6 3 Units of Movement

2 or 5 moves 2″

3 moves 1 unit of movement

4 does not move. 0 units of movement

### Technical Concepts and Language (Glossary)

In human sciences, sports sciences, and social sciences in general, concepts and language vary, and sometimes they do in short lasting terms. For these specific purposes, we use the following basic meanings, since we have used at least once in the period of R & D:

In order to lead to exchanges between Psychologists, Educational Psychologists, Teachers, Graduates in Physical Education, Sports Technicians and others, we cite, for example, some concepts that are common to our practices, and are expected to find under these disciplines.

| | | |
|---|---|---|
| Accessibility | Certainty | Depression |
| Accommodation | Cognition | Lose |
| Acquisition | Catch | Lac of motivation |
| Adaptation | Competition | Dysphasia |
| Aphasia | Communication | Learning devices |
| Affectivity | Conditioning | Chronological age |
| Threats | Conquest | Mental age |
| Apperception | Perceptual | Egocentrism |
| Anterograde | constancy | Exercise |
| Anticipation | Counterattack | Full |
| Learning | Cooperation | Trial- Error |
| Motor area | Coordination | Training |
| projection area | Construction | Scale |
| Attacks | Constructionism | Graphic space |
| Attention | Creativity | Recreational area |
| Esteem | Growth | Body map |
| Chance | Weaknesses | Stimulation |
| Blockade | Deductions | Strategy |
| Quality | Defenses | Stage of |
| Capture | Sport | development |
| Load | Team Sport | Euphoria |
| Feasibility | Move | Orientation |
| Factor | Laterality | Wall |
| Fatigue | Language | Thought |
| Fair Play | Body language | Lateral thinking |
| Failure | Leadership | Perception |
| Mnemic failure | Lobe | Perceptual motor |
| Mental fatigue | Logic | Plan |
| Phases | Ludic | Cognitive plasticity |
| Figure background | Maturation | Positions |
| Flexibility | Memory | Position |
| Fluency | Memory ST, LT | Pressure |
| Strengths | Working Memory | Pressing |
| Brain functions | Metacognition | Principles of |
| Glia | Molding | proximity, |
| UGB | Motivation | continuity, |
| Hypothesis | Driving | similarity, contrast, |
| Integration | Motion | closing |
| Uncertainty | Special Ed needs. | Projection |
| Incorporation | Neuron | Reasoning |
| Introjection | Neurological | Restructuring |
| Intelligence | Neuroplasticity | Performance |
| Multiple | Normality | Mental retardation |
| intelligences | Observation | Retention |
| Intensity | Manual Oculus | Retrograde |
| Intercept | Oblivion | Role playing |
| Interference | Opportunities | Feeling |
| Intuition | Organize | Sensoperception |
| Serialization | Tactic | Absolute value |
| Symmetry | Sporting talent | Positional Value |
| Syndrome | Task | Relative value |
| Synthesis | Systems theory | Reaction rate |
| System | Motor difficulty | Visuospatial |
| Autonomous NS | work in pairs | I |
| Central NS | Group work | Development Zone |
| Systematization | Individual work | |
| Problematic | Tunnel | |
| situation | Threshold | |

### 1. FUTTDAM Glossary (Specific)

### Space

### Work Space

That in which exercises are specifically practised and in which the technician can intervene.

It includes:

Physical contextual space (e.g. room)

educational specific work (tables and similar)

exercise space (platform of exercise: board)

### Exercise Space

Area comprised in the exercise platform (board), supplies on tables and similar (exceeding pieces, die, registration forms)

### Unit of Spatial Motion

U of M: also called frame, square, etc and represents 1/56 of the surface of the FJ space, in one colour and design (green) or the 1/77 of the FM space, in one colour and design is identified by coordinates parameters of row, column, right, left

FJ Space: what we call FUTTDAM JUNIOR and JUNIOR PRO. It comprises 9 rows and 7 columns divided in squares by colours

FM Space: what we call FUTTDAM MASTER, MASTER PRO, and MASTER LIBERO. It comprises 11 rows and 7 columns divided in squares by colours

Zonal Space:

it is the subdivision of the exercise spaces. Arranged in coordinates of rows and columns in order to set rules of operation-intervention between students and technicians (they set limits, restrict of extend moves, etc). There are of three types: rectangular, circular or composite (circular-square)

### Time

T of En: time of encounter is that used by participants and technicians for the development of the activity (training, exercise, educational interventions)

T of W: time of work required to develop a complete exercise.

M T: maximum time allowed for the execution of an operation by each participant. Generally up to 1 minute each.

### Colors in Zonal Space

IN FJ: yellow rows 4, 5 and Yellow middle line dividing the center horizontally, row 5 middle zone. Yellow circle intersecting the central unit of movement (frame or square of row 5, col. 3, and the 8 adjacent U of M.

IN M: Master (pro and libero): magenta rows 4 to 8. Yellow middle line dividing the center. Middle zone. Yellow circle intersecting the central unit of movement, comprising rows 5, 6 and 7, and the 8 adjacent U of M.

External border: in shades of grey or black. Marks the perimeter of the space of exercise.

### Colors

Use of Colors: These promote the perceptual differentiation exercise spaces, spatial movement units, and colored pieces of exercise platform (boards).

Being contrasting but avoiding perceptual/neurological excessive fatigue, they can include units of spatial movement that acquire colors and different shades, alternate one to one. The current FUTTDAM version is set in shades of dark green (similar pitch) and light green.

Tiles Color Code: These can acquire various colors or color settings. They distinguish the tiles corresponding to each participant and their functions or operations.

Overall level: three contrasting groups (eg blue, orange, yellow, white, black, red, etc.).

Specific operational level: one of the three colors distinguish the tiles with mobility in X (right, left, up, down).

Colors of parts: There are three main groups: in shades of blue, orange and yellow. Some, by their displacement potential (which move in X) will have visible line, mark or differential signalling in one of the three colors. There are motion units (U of M) in rows 1 and 7, central column FJ distinguished by pattern in orange (cross)

There are U of M in Master (pro and release) in rows 1, 3, 9 and 11 which are distinguished by orange pattern (cross)

Terminology: As it is apparent, in some typical examples we used calculation program concepts and Excel spreadsheets. This has been very useful to exemplify plays and movements, and also avoids the typical abstraction of, for example chess, whose representations in combination of letters and numbers are too complex for the people we work with.

We use the concept of row and column associated with numbers that barely exceed the ten. This makes it simple and easily associable with psychomotor activities, where proper use of oneself and others' left and right are essential. By practicing this language, FUTTDAM indirectly favours psychomotor stimulation.

### Objectives and Technical Goals

### a) Overview

i. Be clear about our Management Diagram (PERT) in the organizational aspect, and lead to the progress of activities on a regular, planned, recorded and high quality technical manner

ii. Select to each particular case, the items of utility corresponding to each student/family/group

iii. Keep in mind that FUTTDAM, is a technical-scientific method when in the hands of professionals, but in its free use by novices can become only recreational.

iv. Use with whom we work, progressively, all the principles mentioned in item 3.

v. If there are more principles deemed relevant, try to include tem.

vi. The technical purpose of FUTTDAM is not competitive, but fits the expressed in item 3.

vii. Promote the integrity of principles, rather than isolated fragmentation of the same.

viii. Go from little benefit to the highest benefit.

ix. FUTTDAM′ progression is not an area of valuable work by itself, and therefore, must be subordinated to the general set of practices, methods, resources and techniques that can be framed.

x. Pass from the abstraction of group and team situations, to the implementation of material conditions akin to those worked on.

xi. Respect the limits that the student expresses in each instance (fatigue, disinterest, failures, etc.)

xii. Try the maximum development of the participants in both FUTTDAM′ practice and training does not represent a loss in the general objectives of the technician-patient and teacher-student relationship, etc.
xiii. Evaluate, record, compare, and track instances worked

### b) Session by Session

It is convenient to set definite objectives.

These may comprise, for each person/group:

One or more of those mentioned in item 3

Reducing the times between the exercises carried out in a given session and those in the previous session

Structuring specific tactics and strategies

Increasing efficiency to end a round

Encouraging cooperation between participants

Fostering dialogue interventions in each session

Improving the performance of each participant in any aspect

Others deemed useful to the process

Aspects FUTTDAM work on in the field of educational and psychomotor psychology

It abstracts groups and teams situations

It contributes to improving tactical and strategic approaches

It shows performances and/or evolutions of students

It is challenging, motivating

It stimulates cognitive plasticity, lateral thinking, upper brain functions, general and specific cognitive and intellectual skills

It requires analysis and synthesis, projections, deductions and anticipations, speculation

It fosters learning potential development and adaptability

It promotes cooperation and leadership between children

It favours variable rhythms and intensities at each level of intellectual work

It blends aspects inherent to Strategic thinking with Tactical and Intuitive Thinking

Its progression has five stages of increasing complexity

The progression has characteristics of Sports Sciences, Psychology, and

Psychology Psychomotor

Means of recreation, fun

It can rotates activities, enrichment, or work stations.

Promotes better understanding of the bonds and limit setting,

Promotes mental representations of sport

Strengthens psychomotor performance

It fosters relationships and bonds

Positive impact on quality of life and autonomy

Work with FCS and DBA; Perceptual-visual, Observational Attentional, mnemonic, Inferential, Intuitive, Analytical, Synthetic, Affective, Ethics, Globalizing, Structuring, Organizing, Associating, Empathy, value (valiance)

Stimulates inter and intra-generational socialization

Basic principles and corresponding educational psychology training:

Self-Knowledge

Total quality

Cyclicality loads

Continuity

Intervention focus

Gradual habit and practice

Individualization

Multilateralism specialization

Progressivity of loads

Progress of Men

Respect for student needs and interests

Health

Variability

### Examples

### Examples of Teaching Exercises Selected by a Teacher in Accordance with the Goal Set

### Problem Situations

Create a situation that: In Phase 1 (Junior), the coordinates of the Units Displacement are Right Row 2, Column 2 and 5, and the opposite side symmetrical.

maximum regulated time: 1 minute

In the same Zonal Space of the previous exercise, place a piece that can move horizontally, at least 4 consecutive Units of Movement.

RT: 1 minute

Demarcate an zonal space which is crossed by half by the Middle Line, and has an area of 25 units of Movement

RT: 2 minutes

In the previous Zonal Space, place a Blue, and 4 orange tiles, so that whatever the number given by the die is, this formation cannot be surpassed.

RT: 3 minutes

Perform the aforementioned exercise, so that if two Orange tiles can move 3 squares, both go over the blue one.

RT: 2 minutes

Demarcate an zonal space, in a way that the Right unit of Movement is located at twice Units than the Left, and these units twice its symmetrical in the opponent's area.

If each square is 3 m side, what is the area of that surface?

RT 4 minutes

In the previous Zonal Space, place a blue tile with movement in X, and two more blue with movement in V, so that if in a corner I put a Orange piece that moves in X, this, can jump over the two blue, bouncing two squares, and giving its first forward move of 3 Units of Movement.

RT: 2 minutes

If we reciprocated the previous Zonal Space, with cardinal points and the North, is the square nearest to your Right, in which direction has the Orange tile traveled, and if each Unit of Motion, equals 1, 6 km diagonally [symbol] how many meters has it traveled?

RT: 5 minutes

Assuming that the tables calculated in the previous Zonal Space are acquired for the free movement of people (such as a local road), what surface is left without pavement? (Remember that 1.6 km is the diagonal of a square, and we want the surface of it). RT: 5 min.

### Exercises

Draw up a world map with the capitals of the marked countries such that the size thereof completely overlaps the board of FUTTDAM Master.

Place it horizontally in front of you.

Imagine that the lines of the rows and columns of the board are land parallels and meridians.

a) describe in which coordinates are the capitals of: Uruguay, Mexico, England, Japan, using reference rows and columns (right and left).

b) if each box (unit movement) has 500 km aside, what distance in a straight line does a traveler go from Montevideo to each capital.

c) how many km would he go if he makes a trip starting in Mexico and ending in Montevideo, without passing twice on the same city?

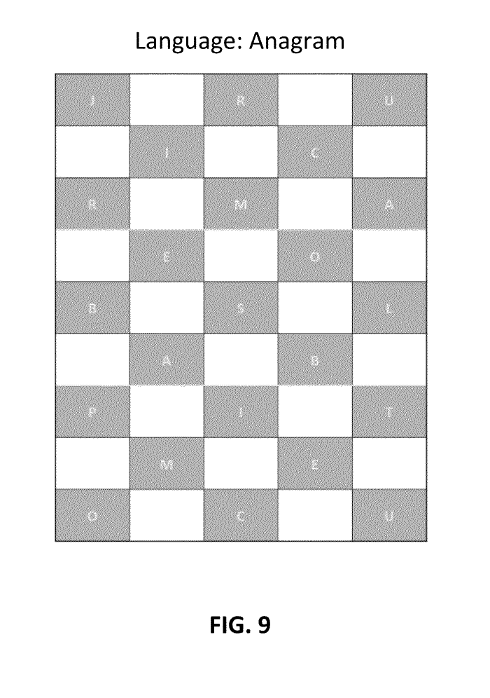

As illustrated in FIG. 9, using a FUTTDAM JUNIOR board, we use squares to correspond with them a grid containing letters drawn randomly. As we will have 23 squares, part of the alphabet will be used so that 10 frames are vowels and 13 are consonants (placed at the discretion of the teacher). Every 8 movements, which will be marked on the grid, it will stop the game, and the players will try to form a word of at least 4 characters, combining the ones marked on the grid, whose example is placed below.

With high school students, Master's board and letter proportion/distribution criteria and gridding of movement may be used at the choice of teachers.

### In Psychomotor Room or Sports Court.

Materials: floor designed with squares (Eg rubber 1 m×1 m) or chalk grids and colors to reproduce part of the board FUTTDAM Jr. or Master (an area).

### Instructions:

Role Playing where kids take specific training game and must themselves make a play prepared by the technician. It allows and requires a solution reached through group dialogue and encourages mutual understanding of viewpoints.

### Instructions:

In a similar play area, two children and 4 prisms assume to be defenses. Four prisms and two others attack. Each team has players with assigned values (eg, Goalkeeper is worth 4 points, midfielder 5, wildcard 6, ordinary player 1) distributed tactically.

Problem to solve: if I withdraw players from each side randomly, eg goalkeeper and one regular player from one; and a midfielder and two regular players from another, what should happen in order to restore the mathematical balance of forces before the change? Is the balance measured in points in the game or dependent on something else? Specify in case of positive response and propose solutions.

### Useful Mathematical Exercises

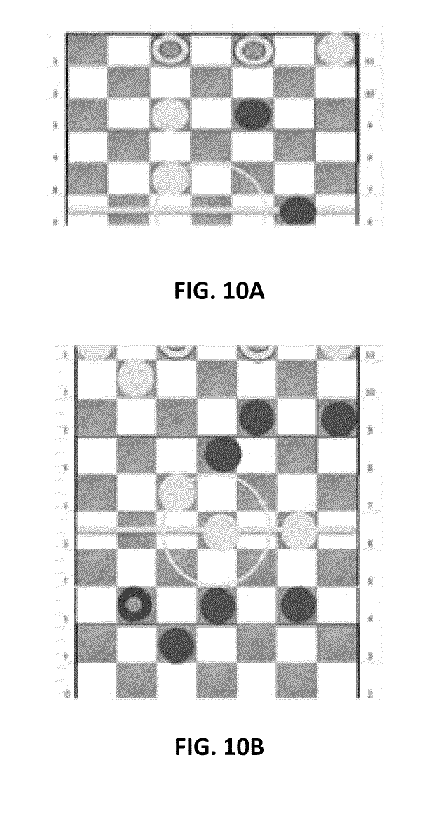

In FIG. 10A, observe the following position:

Move: Blue (dark)

If the tiles that move in V are worth 1 point, the ones in X, 3 and wildcards are worth 6 points, establish a mechanism of movement so that the pieces you see in the picture give equal value for light and dark.

In the previous exercise, if each square is worth 50 dm, how many meters were toured in order to reach the tie? who moved more and how many cm was the difference between one and another team? what percentage of the visible field in this tactical approach was not used by any player?

What linear distance is traveled by a ball if the result of the die is 2 and the diagonal of a square of 4 cm side rises (at its point of maximum height)

Calculate the corresponding falling distance if it falls in a position to catch.

Observe the table in FIG. 10B.

a) Develop 2 moves, being able to use 2 times the die for each (light or dark players) from the present situation, so that dark midfielder (red borders) which is in col 2 left, row 4, can reach the opposite col 2 right row 8.

b) Develop a move so that the same can return to its initial position, but following a path other than any of the previous ones.

### Levels

The teacher will select the level in accordance with the learner's prior evaluation.

### Phase 1 Junior Version

This is a basic version, relatively simple in the context of progression. Its methodological inclusion purpose that of satisfying the interests and requirements of the younger players, and technically speaking, to promote better a understanding of the game, having increasing degrees of complexity, facilitating the development of tactical thinking akin to football without too complicated situations, but introducing rules/options that resemble some of the possible situations in a field, and other different, innovative, that stimulate creative and strategic thinking.

It also has fewer tiles, so its value, imaginarily recreates an 8 vs. 8 game or similar,—average children's football in our country (7-9 players in different categories).

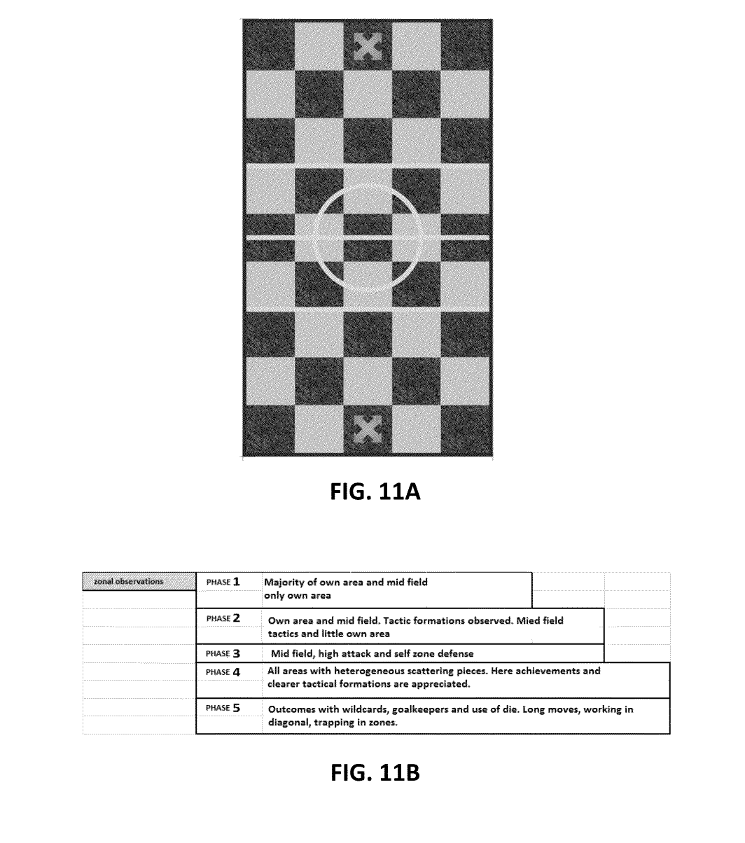

Non restrictive example of board for Junior and Junior Pro versions are provided in FIGS. 11A and 11B.

Pieces Mobility

| | | | Field | | |
|---|---|---|---|---|---|
| trajectory | Tiles | Direction | area | Situation | Exception |
| 1 square | Any | Advance | All | Regular | Goalkeeper |
| | | | | move | and |
| | | | | | miedfield |
| | | | | | lines |
| 1 square | Goalkeeper | Setback | Mid Z | Retreat | Zonal line |
| | Miedfielder | Setback | Mid Z | Retreat | (ZD) |
| | Wild cards | Setback | Mid Z | retreat | Zonal line |
| | | | | | (ZM) |
| In X | Goalkeeper | Setback/ | Own Z | Regular | |
| | Miedfielder | advance | Own Z | move | |
| | Wild cards | | all | | |
| Two S | Any | Advance | All | Catch | GK an |
| | GoalK/mid | Setback/ | Own Z | Die | miedfielder |
| | Wild card | advance | All | Regular | Zonal line. |
| | | | | move | Zonal lines |
| | | | | | ZD and ZM |
| Three S | Any | Advance | All | Die | Zonal lines |
| | GoalK/mid | Setback/ | Own Z | Die | ZD and ZM |
| | Wild card | advance | All | Regular | |
| | | | | move | |
| More | Wild card | Setback/ | All | Regular | |
| than 3 | | advance | | move | |

### Creating and Improvising Situations.

According to the experience and interests of technician, a game round does not have to be completed. The search of a winner is not essential to the method as it is learning the tactical articulation of the intellectual level, which involves integration of functions, skills and simpler learning devices serving for the resolution of specific problems that are set in the 5 levels of FUTTDAM.

Therefore, at any reasonable time, we can interrupt a game and simply construct scenarios, for example: create numerical superiority/inferiority in a sector of the board and say “red play” or “blue play”. We add in some area an important piece (eg. Wildcard) and suggest any other changes to the opponent.

The purpose is to train the student/athlete/player with variants which are expected or not, known or which will encourage the player to resolve situations, not to create winners and losers: the psycho educational and teaching process is of more importance than the successful outcome of each game.

### As a Game Akin to Team Sports.

### SKILLS-Innovation

It emphasizes the tactics per areas, expanding the mid zone and constraining the defensive half. It follows the zonal logic. Increases agonistic encounters of “duels” type in middle. Significantly increases the total number of possible moves. Emphasizes and appreciates the importance of the lateral displacements. Expands the use of passes/long shots. Promotes team play more globally, requiring supports, walls, etc.

It helps identifying the organizer and planner player from the improviser one who resort to chance, making possible more balanced thoughts.

It also restricts the mobility of the Goalkeepers, which, makes reference to “reality” because the point of no return is a row ahead.

The new tiles add action to the middle zone; they need others tiles to organize and perform in its multiple positions, articulate defence-attack and agile and effective restructuring.

Similarly, the long-shot (when using the die), can unbalance the game (like any medium shot).

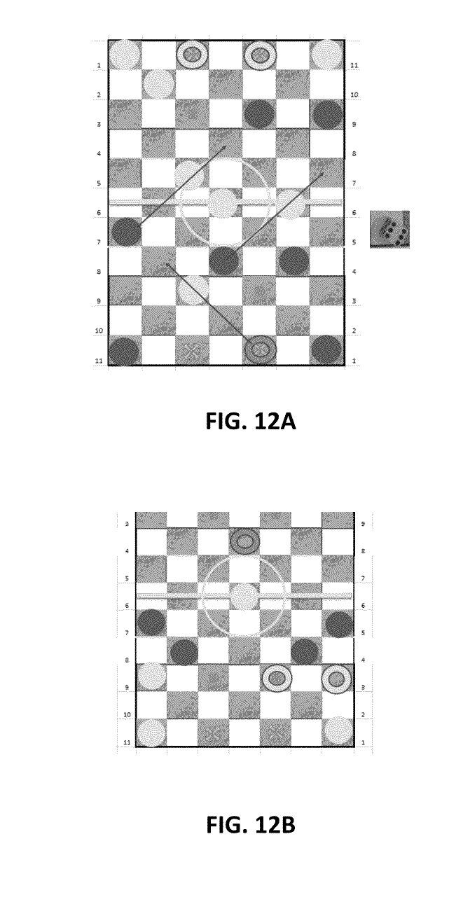

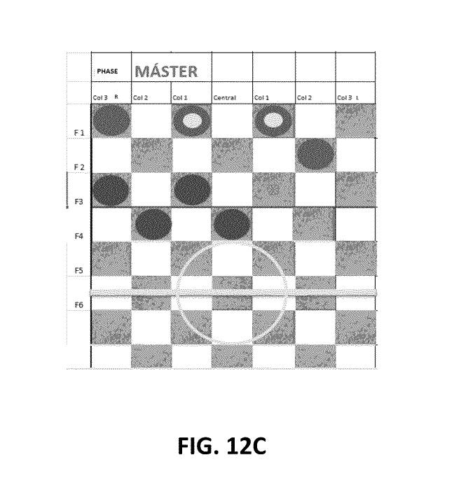

See for example, FIGS. 12A, 12B and 12C.

In FIG. 12A, If black moves, a die can since they have two tiles on the white DZ. If the result is 6, it can move 3 squares. Archer black Row 1 Col 1 may catch white tile of left col 1, row 3 without leaving its area. The other two defensive pieces cannot use three movement squares, then if they do, they just move one square. If you move the 3 squares enabled, black tiles of 3 Left col, row 7 catches a tile of central area. It disables the use of the die given to the white and is left with three in its attack, to the right quadrant, but outnumbered. A similar, less effective move is to forward 2 squares with right middle col, row 8 catching right, col 2 row 6 and also has three players on the same right quadrant attacking outnumbered.

In FIG. 12B, while tiles moved and black moved forward all whites, and its goalkeeper in column 3, row 5 contains the one in the central area. Black GK in right col, row 3 cannot catch by zonal boundary. Black to move right column 2, row 4 and threatens white goalkeeper also limiting the catch. White moves: roll the dice looking to move forward 2 or 3 squares? If you get 2, may return a GK. They catch by obligation col 2 left, or let overlap and recede archer? What move and what team? Strategy of tight defense or long and deep attack?

In FIG. 12C, Blue moved: a) what tactics red has to se to obtain a wildcard, in the most advantageous situation-losing fewer tiles and in less movements—if not, they obtain a 3 square advance? B) How many possible moves are there to get a wildcard, if the red never gets exactly two squares forward by using a die? C) Describe the previous move using FUTTDAM terminology.

### Applicable Rules:

A, 14, 1, 1 using the die

C, 8, advance of goalkeeper

C, 15, using die

F, 5, positioning

### FUTTDAM Accompanies the Maturational Growth.

Progression takes part in the proper development of the spatial organization. In this sense, the ability to guide and direct the movements within the space is essential for survival and proper human development.

Reference is a key factor in the apprehension of space. Every named object shapes the space around and appears as the centre of a local map structure whose poles are the same as the ones of the body schema: up-down, front-back, right-left.

In these games, the child must bring into play a spatial behaviour, called allocentric space. The same is based on spatial representations where the environment serves as a framework for a system of coordinates independent from the observer, Cartesian coordinates, relative position of several objects (tiles in this case). In everyday life, egocentric (perception of spatial location outside the body, but with reference thereto) and allocentric reference frames interact to generate a sense of space.

On the other hand FUTTDAM strengthens patience —impulse self control-when waiting for turns, it encourages children to make decisions calmly since proper planning, foresight and use of strategies and tactics are required. This could also help children understand that thinking of a course of action to take and making the right decisions lead to better results. The latter could be transferred to all behaviours developed by child in their daily lives, which would result beneficial, especially in the “era of immediacy” to which we are all exposed, where often “doing” is put ahead of “thinking how to do.”

It is a game that can be used in a psychomotor room, while it is possible to take the game from its board to the wide space of the room, i.e. play the game dynamically by using pieces of cardboard, ninepins, balls, among other materials, and play the tactical moves with motor skills involving the whole body, through general dynamic coordination.

It follows the maturation pathway of the child-teenager.

1. Psycho educational method for psychomotor, spatial, rational, strategic and intuitive learning-among other purposes. Characterized by being the sum of spatial and strategic concepts of various games (two-dimensional space) and sports (three dimensional space): football, hockey, handball, volleyball, basketball, and others, together with chess, checkers and others, being not only a game of skill but also including a chance factor given by a die, teetotum, or similar elements. It is further characterized by the psycho educational method which has several levels to be used in conjunction with the opinion of a teacher and considering the student's needs, thereby contributing to teamwork, social integration, overcoming of different personal deficiencies and giving access to labour market through a psychological, psychomotor and social improvement that facilitates, among other things, the handling with machine tools and social and work integration into a plural environment governed by rules that may be subject to continuous change and growing difficulties.

2. The scientific-experimental method that resulted from the development of this psycho-educational method and teaching tool.

3. All difficulty levels set out in the specification and any others that may arise from the application of the concepts and methods disclosed herein, whether those upper, middle or lower levels.

4. The method described in claim 1, applied to both normal and disabled children and adults.

5. The ideal tool for applying the method of claim 1 consists of a very distinctive board and tiles, as exemplified in the specification, or similar but applicable to the described psycho-educational method which admits variations in terms of squares arrangement, zones and number of dice, teetotums, roulette or other elements of chance. The latter does not necessarily need to be one, but may be in other variations suitable to the method and used for other sports apart from or instead of football, also admitting other colours.

6. Any variation of the tool described in claim 5 for its adaptation to other social and cultural environments where football is not the main sport, or its simplification using games which are simpler than chess or checkers, such as Ludo, or its complexity by the inclusion, for example, of Chinese checkers among others.

7. Any use of the methods of claim 1, in any of their applications and levels, for its use by any electronic and/or electro-mechanical means, including its use it in physical spaces indoors or outdoors.

8. Any use of the tool of claim 5, in any of its variations, for its use by any electronic and/or electro-mechanical means, in indoors or outdoors spaces.
